(19) United States
(12) Patent Application Publication
(10) Pub. No.: US 2012/0099073 A1
(43) Pub. Date: Apr. 26, 2012

(54) RUBBING METHOD AND METHOD OF FABRICATING LIQUID CRYSTAL DISPLAY DEVICE USING THE SAME

(75) Inventors: Seung-Ryull PARK, Goyang (KR); So-Young NOH, Seoul (KR); Sung-Ki KIM, Goyang (KR); Jin-Pil KIM, Paju (KR); Kyung-Mo SON, Paju (KR); Jae-Won LEE, Goyang (KR)

(73) Assignee: LG DISPLAY CO., LTD., Seoul (KR)

(21) Appl. No.: 13/277,777

(22) Filed: Oct. 20, 2011

(30) Foreign Application Priority Data
Oct. 21, 2010 (KR) 10-2010-0103107

(51) Int. Cl. G02F 1/13; H01J 9/00

(52) U.S. Cl. 349/187; 445/24

(57) ABSTRACT

A rubbing method and a method of fabricating a liquid crystal display (LCD) device using the same are discussed. The rubbing method is capable of decreasing disclination and rubbing tails resulting from a pattern of a high stair-step such as a column spacer. The rubbing method includes loading a substrate having an alignment layer formed thereon on a stage; performing a primary rubbing process on the alignment layer, by rotating a first rubbing roll on which a first rubbing cloth is rolled, in an opposite direction to a forming direction of a desired pretilt angle; and performing a secondary rubbing process on the primarily-rubbed alignment layer, by rotating a second rubbing roll on which a second rubbing cloth is rolled, in the forming direction of the desired pretilt angle.

### CROSS-REFERENCE TO RELATED APPLICATION

This application claims the benefit of Korean Patent Application No. 10-2010-0103107, filed on Oct. 21, 2010, which is hereby incorporated by reference for all purposes as if fully set forth herein.

### BACKGROUND OF THE INVENTION

1. Field of the Invention

The present invention relates to a rubbing method and a method of fabricating a liquid crystal display (LCD) device using the same, and particularly, to a rubbing method through bidirectional rubbing and a method of fabricating an LCD device using the same.

2. Description of the Related Art

As concerns about an information displays and demands for portable information media are increased, research and commercialization of flat panel displays (FPD) replacing the conventional display apparatus, Cathode Ray Tubes (CRT) are actively ongoing. One of these flat panel displays, a Liquid Crystal Display (LCD) device serves to display an image by using optical anisotropy of liquid crystal (LC). Owing to an excellent resolution, color reproduction characteristic, and picture quality, the LCD device is being actively applied to a notebook, a desk top monitor, etc.

Generally, the LCD device indicates a display device capable of displaying a desired image by controlling each optical transmittance of LC cells arranged in a matrix form, by individually supplying data signals according to image information to the LC cells.

Hereinafter, the LCD device will be explained in more details with reference to FIG. 1.

FIG. 1 is a disassembled perspective view schematically illustrating a structure of a liquid crystal display (LCD) device in accordance with the related art. As shown in FIG. 1, the LCD device largely comprises a color filter substrate 5, an array substrate 10, and an LC layer 40 interposed between the color filter substrate 5 and the array substrate 10.

The color filter substrate 5 consists of a color filter (C) composed of a plurality of sub color filters 7 for implementing red, green and blue (RGB) colors, a black matrix 6 for dividing the sub color filters 7 from each other and shielding light passing through the LC layer 40, and a transparent common electrode 8 for applying a voltage to the LC layer 40.

The array substrate 10 consists of a plurality of gate lines 16 and data lines 17 arranged in horizontal and vertical directions to define a plurality of pixel regions (P), Thin Film Transistors (TFT), switching devices formed at each intersection between the gate lines 16 and the data lines 17, and pixel electrodes 18 formed in the pixel regions (P).

The pixel region (P) indicates one sub pixel corresponding to one sub color filter 7 of the color filter substrate 5. Here, a color image is obtained by combining the three types of sub color filters 7 (RGB) with one another. That is, three sub pixels (RGB) constitute one pixel, and thin film transistors (T) are connected to the sub pixels (RBG) respectively.

Alignment layer (not shown) for aligning LC molecules of the LC layer 40 are printed on the color filter substrate 5 and the array substrate 10. Here, the alignment layer is formed by a printing method using a plurality of rolls.

The alignment layers formed on the color filter substrate 5 and the array substrate 10 are rubbed such that liquid crystal is oriented in a constant direction. As a result, grooves are formed in a constant direction.

FIG. 2 is a perspective view schematically illustrating a rubbing process in accordance with the related art.

As shown in FIG. 2, an alignment layer (not shown) formed on the substrate 10 undergoes a rubbing process such that grooves are formed on the surface of the alignment layer. This rubbing process indicates rubbing the surface of the alignment layer in a constant direction with using a rubbing roll 30 having a rubbing cloth 35 rolled thereon.

Although not shown, once the surface of the alignment layer is rubbed, minute grooves are formed on the surface of the alignment layer.

As the rubbing cloth 35, a cloth formed of soft fiber is used. Rubbing equipment including the rubbing roll 30 is comparatively simple.

Generally, a rubbing process is performed by a single rubbing in a forming direction of a desired pretilt angle.

Due to a pattern of a high stair-step such as a column spacer (CS) formed between the pixel regions (P), a rubbing process may not be normally performed at the end of the pattern. This may cause disclination, rubbing scratches, rubbing tails, etc. In this case, black brightness may be increased regardless of whether the alignment layer is determined to be inferior or not.

This problem may result from the rubbing process, and may occur as the rubbing cloth 35 does not normally pass through the end of the pattern. The higher the height of the pattern is, the inferior the rubbing process becomes. Furthermore, the rubbing process may not be normally performed at the end of the pattern as the rubbing cloth 35 is inclined to one side according to a shape of the pattern. This may be influenced by a pattern shape or a direction of the rubbing cloth 35.

Besides, the black matrix is limited to have a size more than a predetermined value for prevention of light leakage occurring due to the pattern of a high stair-step. This may decrease an aperture ratio and brightness.

### SUMMARY OF THE INVENTION

Therefore, an aspect of the detailed description is to provide a rubbing method capable of decreasing disclination and rubbing tails through bidirectional rubbing, and a method of fabricating a liquid crystal display (LCD) device using the same.

To achieve these and other advantages and in accordance with the purpose of this specification, as embodied and broadly described herein, there is provided a rubbing method, comprising: loading, on a stage, a substrate having an alignment layer formed thereon; performing a primary rubbing process on the alignment layer, by rotating a first rubbing roll on which a first rubbing cloth is rolled, in an opposite direction to a forming direction of a desired pretilt angle; and performing a secondary rubbing process on the primarily-rubbed alignment layer, by rotating a second rubbing roll on which a second rubbing cloth is rolled, in the forming direction of the desired pretilt angle.

To achieve these and other advantages and in accordance with the purpose of this specification, as embodied and broadly described herein, there is also provided a method of fabricating a liquid crystal display (LCD) device, the method comprising: providing a mother substrate having thereon a plurality of array substrates and a mother substrate having thereon a plurality of color filter substrates; performing an array process with respect to the array substrates, and performing a color filter process with respect to the color filter substrates; forming an alignment layer on each surface of the mother substrates having undergone the array process and the color filter process; performing a primary rubbing process on the alignment layer, by rotating a first rubbing roll on which a first rubbing cloth is rolled, in an opposite direction to a forming direction of a desired pretilt angle; performing a secondary rubbing process on the primarily-rubbed alignment layer, by rotating a second rubbing roll on which a second rubbing cloth is rolled, in the forming direction of the desired pretilt angle; attaching the pair of mother substrates having undergone the rubbing process to each other; and cutting the attached mother substrates into a plurality of unit LCD panels.

The step of forming an alignment layer may include depositing an alignment material formed of an organic polymer on the mother substrate; primarily drying the alignment material to a temperature of 60° C.˜80° C.; and hardening the alignment material at a temperature of 80° C.˜200° C.

The primary rubbing process may be performed with moving at least one of the stage having the mother substrate loaded thereon, and the first rubbing roll.

The secondary rubbing process may be performed with moving at least one of the stage having the mother substrate loaded thereon, and the second rubbing roll.

Hairs of the first and second rubbing clothes may be configured to be inclined toward one of the left side, the right side and the middle side with respect to a vertical direction of rotation axes of the first and second rubbing rolls. Here, the hairs may have an inclination angle of 5°˜37° in the right and left directions.

Liquid crystal may be dropped onto one of the mother substrates having undergone the rubbing process and having thereon the array substrates and the color filter substrates, and a sealant may be coated onto another mother substrate.

The mother substrate having the liquid crystal dropped thereon may be attached to the mother substrate having the sealant coated thereon.

A spacer may be formed on one of the mother substrates having undergone the rubbing process and having thereon the array substrates and the color filter substrates, and a sealant may be coated onto another mother substrate.

The mother substrate having the spacer formed thereon may be attached to the mother substrate having the sealant coated thereon. Then, the attached mother substrates may be cut into a plurality of LCD panels, and liquid crystal may be injected into the LCD panels.

The present invention may have the following effects.

Firstly, a primary rubbing process may be performed in an opposite direction to a forming direction of a desired pretilt angle, and then a secondary rubbing process may be performed in the forming direction of the desired pretilt angle. This may decrease the occurrence of declination and rubbing tails due to a pattern of a high stair-step such as a column spacer. As a result, black brightness of an image may be decreased, and a contrast ratio may be increased.

Furthermore, the black matrix may have a reduced size due to decreased rubbing tails. This may enhance an aperture ratio.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a disassembled perspective view schematically illustrating a structure of a liquid crystal display (LCD) device in accordance with the related art;

FIG. 2 is a perspective view schematically illustrating a rubbing process in accordance with the related art;

FIG. 3 is a perspective view schematically illustrating a rubbing process according to the present invention;

FIG. 4 is a flowchart illustrating a method of fabricating a liquid crystal display (LCD) device according to one embodiment of the present invention;

FIG. 5 is a flowchart illustrating a method of fabricating a liquid crystal display (LCD) device according to another embodiment of the present invention; and

FIG. 6 is a flowchart illustrating a rubbing method in the method of fabricating an LCD device shown in FIGS. 4 and 5.

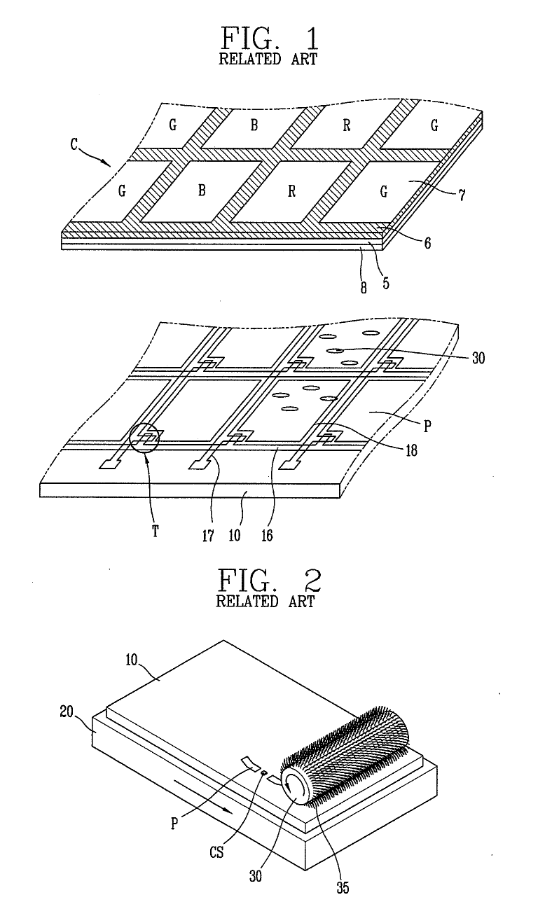

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

Hereinafter, a rubbing method and a method of fabricating a liquid crystal display (LCD) device using the same according to the present invention will be explained in more details with reference to the attached drawings.

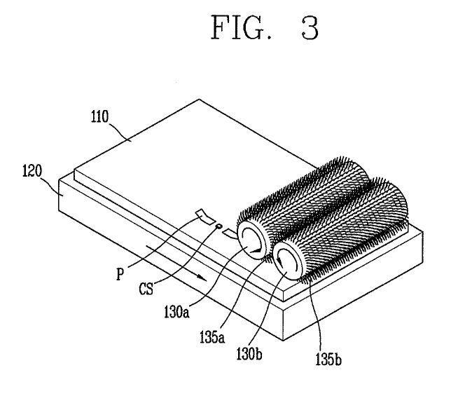

FIG. 3 is a perspective view schematically illustrating a rubbing process according to the present invention.

As shown, a rubbing apparatus according to the present invention comprises a first rubbing roll 130a and a second rubbing roll 130b rotated in different directions for bidirectional rubbing, a stage 120 disposed below the first rubbing roll 130a and the second rubbing roll 130b and having a substrate 110 mounted thereon for rubbing, and a transferring means (not shown) disposed above the first rubbing roll 130a and the second rubbing roll 130b and configured to transfer the first rubbing roll 130a and the second rubbing roll 130b.

The stage 120 is formed in a rectangular shape having long and short sides. Here, the first rubbing roll 130a and the second rubbing roll 130b may be arranged in a direction of the long sides of the stage 120.

Each of the first rubbing roll 130a and the second rubbing roll 130b is formed in a cylindrical shape having a rotation axis and an outer circumferential surface. A first rubbing cloth 135a and a second rubbing cloth 135b are rolled on outer circumferential surfaces of the first rubbing roll 130a and the second rubbing roll 130b, respectively.

The first rubbing cloth 135a and the second rubbing cloth 135b are fabrics such as velvet or cotton flannel, which are formed by weaving soft textiles such as rayon, nylon and cotton on a material textured with using warp and weft. The first rubbing cloth 135a and the second rubbing cloth 135b serve to form a predetermined pretilt angle by rubbing an alignment layer of an LCD device.

Although not shown, a driving means (not shown) such as a motor is connected to the first rubbing roll 130a and the second rubbing roll 130b, thereby allowing each of the first rubbing roll 130a and the second rubbing roll 130b to rotate centering around a rotation axis.

In order perform a rubbing process by the rubbing apparatus, the substrate 110 having an alignment layer (not shown) thereon is loaded on the stage 120.

The alignment layer may be formed by depositing an alignment material formed of polyamic acid which is an organic polymer, soluble polyimide, etc. on the substrate 110, by drying the alignment material to a temperature of 60° C.˜80° C., and then by hardening the alignment material at a temperature of 80° C.˜200° C. The hardened alignment layer is made to be polyimide.

Here, the alignment layer may be formed to cover the entire surface of the substrate 110 including a column spacer (CS).

The alignment layer formed on the substrate 110 undergoes a rubbing process so as to form grooves on the surface thereof. One of the most important things to be considered when setting rubbing conditions is to determine a proper rubbing strength, and to uniformly apply the rubbing strength on a large area of the substrate 110.

In the present invention, a primary rubbing process is performed with respect to the alignment layer. Firstly, the first rubbing roll 130a having the first rubbing cloth 135a rolled thereon is backward rotated. Then, at least one of the stage 120 having the substrate 110 loaded thereon and the first rubbing roll 130a is moved. More concretely, while moving the stage 120 from one side of the substrate 110 to another side of the substrate 110 along a direction of the arrow, the first rubbing roll 130a is rotated in a direction opposite to a forming direction of a desired pretilt angle, (i.e., clockwise direction). Through this, a primary rubbing process is performed.

Here, hairs of the first rubbing cloth 135a may be inclined toward one of the left side, the right side and the middle side with respect to a vertical direction of a rotation axis of the first rubbing roll 130a.

The hairs may have an inclination angle of 5°˜37° in the right and left directions.

A rubbing cloth may be categorized into the following three types. When hairs of cloth have a vector component inclined to an opposite direction to a rubbing direction and have a vector component inclined to the left side with respect to a vertical direction of a rotation axis of a rubbing roll, this is referred to as L-type rubbing cloth. When hairs of cloth have a vector component inclined to an opposite direction to a rubbing direction and have a vector component inclined to the right side with respect to a vertical direction of a rotation axis of a rubbing roll, this is referred to as R-type rubbing cloth. When hairs of cloth are parallel to a vertical direction of a rotation axis of a rubbing roll, this is referred to as V-type rubbing cloth.

Preferably, the hairs may have an inclination angle of 5°˜37° in the right and left directions.

Then, a secondary rubbing process is performed with respect to the alignment layer. Firstly, the second rubbing roll 130b having the second rubbing cloth 135b rolled thereon is forward rotated. Then, at least one of the stage 120 having the substrate 110 loaded thereon and the second rubbing roll 130b is moved. More concretely, the second rubbing roll 130b is rotated in a forming direction of a desired pretilt angle (i.e., counterclockwise direction).

Here, hairs of the second rubbing cloth 135b may be inclined toward one of the left side, the right side and the middle side with respect to a vertical direction of a rotation axis of the second rubbing roll 130b.

The first rubbing cloth 135a and the second rubbing cloth 135b may be configured to have various inclined directions such as R-type, L-type and V-type, and various pretilt angles in back and forth directions. An optimum cloth may be selected according to each model with consideration of other conditions such as a mark width, a rotation speed, etc. when performing a rubbing process.

The rotation axis of the first rubbing roll 130a and the rotation axis of the second rubbing roll 130b may be disposed to be parallel to each other.

The bidirectional rubbing of the present invention is implemented by primarily rotating the rubbing roll 130a in an opposite direction (backward direction) to a forming direction of a pretilt angle, and by secondarily rotating the rubbing roll 130b in a forward direction. That is, in the conventional art, due to a pattern of a high stair-step such as a column spacer (CS) formed between pixel regions (P), a rubbing process may not be normally performed at the end of the pattern. This may cause disclination, rubbing scratches, rubbing tails, etc. However, in the present invention, a primary rubbing process is performed in an opposite direction to a forming direction of a pretilt angle, and then a secondary rubbing process is performed in a forward direction. This bidirectional rubbing may reduce disinclination and rubbing tails occurring when performing a unidirectional rubbing process.

Hereinafter, a method of fabricating an LCD device with using the rubbing process will be explained in more details with reference to the attached drawings.

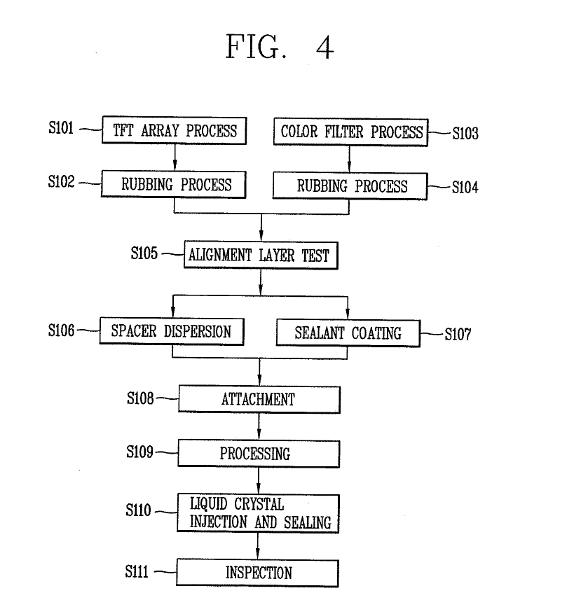

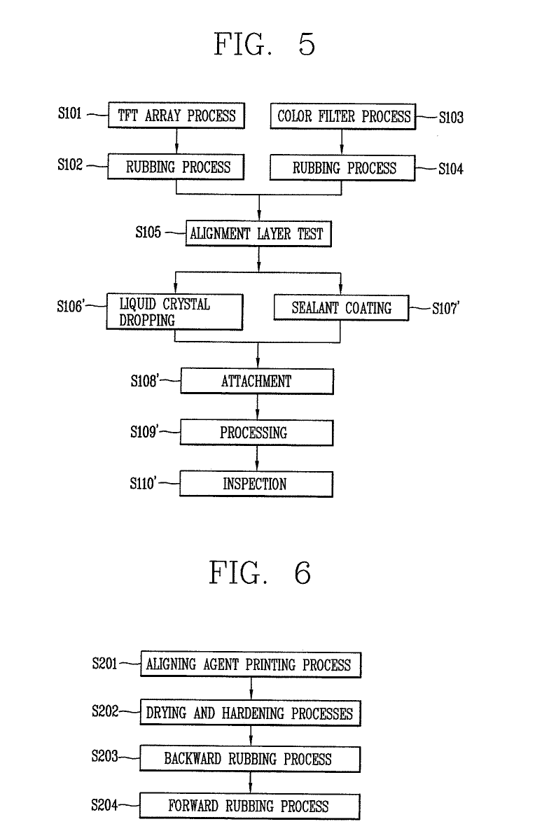

FIG. 4 is a flowchart illustrating a method of fabricating a liquid crystal display (LCD) device according to one embodiment of the present invention, and FIG. 5 is a flowchart illustrating a method of fabricating a liquid crystal display (LCD) device according to another embodiment of the present invention.

FIG. 4 illustrates a method of fabricating an LCD device in case of forming an LC layer through LC injection, and FIG. 5 illustrates a method of fabricating an LCD device in case of forming an LC layer through LC dropping.

A process of fabricating an LCD device may be largely categorized into a driving device array process for forming a driving device at a lower array substrate, a color filter process for forming a color filter at an upper color filter, and a cell process.

Firstly, a plurality of gate lines and data lines which define pixel regions are formed on an array substrate by an array process, and a driving device, a thin film transistor (TFT) connected to the gate line and the data line is formed at each of the pixel regions (S101). Through the array process, also formed is a pixel electrode connected to the TFT and configured to drive an LC layer as a signal is applied through the TFT.

At a color filter substrate, a color filter layer and a common electrode are formed through a color filter process (S103). The color filter layer consists of sub color filters of RGB. In case of fabricating an IPS (In Plane Switching) LCD device, the common electrode is formed at the lower substrate where the pixel electrode has been formed through the array process.

Then, an alignment layer is printed on each of the color filter substrate and the array substrate, and then undergoes a rubbing process in order to provide anchoring force or surface anchoring (pretilt angle and orientation direction) to LC molecules of an LC layer formed between the color filter substrate and the array substrate (S102, S104).

In this embodiment, a primary rubbing is performed in an opposite direction to a forming direction of a pretilt angle, and a secondary rubbing is performed in the forming direction of the pretilt angle. This may decrease the occurrence of declination and rubbing tails due to a pattern of a high stair-step such as a column spacer. This will be explained in more details with reference to FIG. 6.

FIG. 6 is a flowchart illustrating a rubbing method in the method of fabricating an LCD device shown in FIGS. 4 and 5.

Generally, the alignment layer is a very important factor to determine orientations of LC molecules and to enhance display characteristics. The alignment layer is formed of polyamic acid which is an organic polymer, or soluble polyimide-based polymer. After being coated on the substrate, the material is dried, heated and hardened to form the alignment layer.

An aligning agent printing process indicates a process for washing a provided color filter substrate or array substrate, and for uniformly depositing a liquid crystal aligning agent onto one surface of the color filter substrate or the array substrate with using a printing device (S201).

When depositing a liquid crystal aligning agent onto one surface of the color filter substrate or the array substrate, a printing method using a printing device is mainly used. According to the printing method, a liquid crystal aligning agent injected into a plurality of rollers arranged in rows through an inlet is supplied to outer circumferential surfaces of the rollers. Then, the rollers start to print the liquid crystal aligning agent onto one surface of the color filter substrate or the array substrate.

The aligning agent coated on the color filter substrate or the array substrate by this printing method has a thickness of about 40 nm˜80 nm. Once the aligning agent is hardened through the following drying and hardening processes, an alignment layer is completed.

A hardening process (S202) for drying and hardening the liquid crystal aligning agent printed on one surface of the color filter substrate or the array substrate into an alignment layer is performed as follows. In case of using a hot plate method where the color filter substrate or the array substrate having the aligning agent coated thereon is put in a pre-heater and every sheet of the color filter substrate and the array substrate is directly heated, the aligning agent printed through primary low-temperature heating is planarized, and then a solvent of the aligning agent is uniformly evaporated through secondary high-temperature heating.

Then, the color filter substrate or the array substrate is put into a hardening furnace, and then is finally thermally-treated. As a result, the aligning agent is completely implemented as an alignment layer.

Then, the alignment layer undergoes a rubbing process in order to provide anchoring force or surface anchoring to LC molecules of an LC layer formed between the color filter substrate and the array substrate.

Here, the rubbing process is performed as follows. Firstly, a rubbing cloth such as velvet is cut to have a proper size. Then, the rubbing cloth is rolled on an outer circumferential surface of a rubbing roll, and then the color filter substrate or the array substrate having the alignment layer thereon is rubbed by the rubbing roll. Once the surface of the alignment layer is rubbed, minute grooves are formed on the surface of the alignment layer.

In this embodiment, a primary rubbing process (S203) is performed with respect to the alignment layer. Firstly, a first rubbing roll having a first rubbing cloth rolled thereon is backward rotated. Then, at least one of a stage having the color filter substrate or the array substrate loaded thereon and the first rubbing roll is moved. More concretely, while moving the stage from one side to another side of the color filter substrate or the array substrate, the first rubbing roll is rotated in a direction opposite to a forming direction of a desired pretilt angle.

Then, a secondary rubbing process (S204) is performed with respect to the alignment layer. Firstly, a second rubbing roll having a second rubbing cloth rolled thereon is forward rotated. Then, at least one of a stage having the color filter substrate or the array substrate loaded thereon and the second rubbing roll is moved. More concretely, the second rubbing roll is rotated in a forming direction of a desired pretilt angle, thereby performing a secondary rubbing process with respect to the alignment layer of the color filter substrate or the array substrate, the alignment layer having undergone the primary rubbing process.

Here, hairs of the first rubbing cloth and the second rubbing cloth may be inclined toward one of the left side, the right side and the middle side with respect to a vertical direction of rotation axes of the first rubbing roll and the second rubbing roll.

The first rubbing cloth and the second rubbing cloth may be configured to have various inclined directions such as R-type, L-type and V-type, and various pretilt angles in back and forth directions. An optimum cloth may be selected according to each model with consideration of other conditions such as a mark width, a rotation speed, etc. when performing a rubbing process.

The rotation axis of the first rubbing roll and the rotation axis of the second rubbing roll may be disposed to be parallel to each other.

As shown in FIGS. 4 and 5, the color filter substrate and the array substrate having completely undergone the rubbing process undergo an alignment layer test by an alignment layer tester (S105).

If rubbing is not uniform, an alignment degree of LC molecules is not constant. This may cause partial inferiority resulting in other optical characteristics.

A test for rubbing inferiority includes a primary test for testing whether there exist stains, stripes or pin holes on the surface of a coated alignment layer, and a secondary test for testing a uniform degree of the surface of a rubbed alignment layer, and testing whether the rubbed alignment layer has scratches, etc. on the surface thereof.

As the alignment layer tester, a steam tester may be used. Hereinafter, the steam tester will be explained in more details.

The steam tester is provided with a vapor generator therein. In order to test whether an alignment layer is inferior or not, a surface of a substrate where an alignment layer has been formed is exposed to the vapor generator. Then, non-uniformity such as color changes, brightness differences and condensations of the vaporous alignment layer are observed by equipment, thereby testing uniformity. Since the steam tester has a simple process and does not cause damages to a tested substrate, a production yield may be enhanced.

The alignment layer test using the steam tester is performed as follows.

Firstly, a substrate having an alignment layer formed thereon is disposed on a vapor generator. Here, the substrate is installed so as to have a predetermined inclination angle, e.g., an inclination angle of 40°˜50° so that steam, etc. can be easily observed.

Distilled water from the vapor generator is heated to a predetermined temperature, e.g., a temperature of 80° C.˜100° C. to generate vapor. As a result, vapor is formed on the alignment layer of the substrate.

Non-uniformity such as color changes, brightness differences and condensations of the vaporous substrate are observed, from the opposite side, by a user's naked eyes or equipment such as a camera device, thereby testing uniformity of the alignment layer.

Through the alignment layer test, minute defects of the alignment layer or contaminations due to impurities may be tested. In this embodiment, the alignment layer test was performed after a rubbing process. However, the alignment layer test may be performed before a rubbing process.

As shown in FIG. 4, on the array substrate having undergone the alignment layer test, formed is a spacer for maintaining a constant cell gap. A sealant is coated on an outer periphery of the color filter substrate. Then, the color filter substrate and the array substrate are attached to each other with a pressure (S106, S107, S108). The spacer may be implemented as a ball spacer by dispersion, or a column spacer by patterning.

The color filter substrate and the array substrate are formed on mother substrates of a large area, respectively. That is, a plurality of panel regions are allocated to mother substrates of a large area, and a thin film transistor (TFT) and a color filter layer are formed at each of the panel regions. Therefore, the mother substrate has to be cut to be processed in order to fabricate an individual LCD panel (S109). Then, liquid crystal is injected to each of the processed LCD panels through an LC injection opening, and the LC injection opening is sealed, thereby forming an LC layer. Then, each LCD panel is tested to fabricate an LCD panel (S110, S111).

Here, the liquid crystal is injected by a vacuum injection method using a pressure difference. According to the vacuum injection method, liquid crystal is injected into an LCD panel by a pressure difference between inside and outside of the LCD panel, by immersing an LC injection opening of the LCD panel separated from a mother substrate of a large area, into a container disposed in a vacuum chamber and containing liquid crystal, and then by changing a vacuum degree of the chamber. Once the liquid crystal is filled in the LCD panel, the LC injection opening is sealed to form an LC layer of the LCD panel. In case of forming an LC layer at an LCD panel by a vacuum injection method, a seal pattern is partially open to serve as an LC injection opening.

However, the aforementioned vacuum injection method may have the following problems.

Firstly, it takes a long time to fill liquid crystal in the LCD panel. Generally, LCD panels attached to each other have a gap of several μm on an area of several hundreds of cm². Accordingly, even if a vacuum injection method using a pressure difference is applied, the amount of liquid crystal to be injected per unitary time is very less. For instance, in case of fabricating an LCD panel of about 15 inches, it takes about 8 hours to fill liquid crystal in the LCD panel. This long time may lower the productivity. Furthermore, as the LCD panel becomes larger, it takes a longer time to fill liquid crystal in the LCD panel, and inferiority may occur at the time of the filling.

Secondly, the amount of liquid crystal to be consumed is large. Generally, the amount of liquid crystal to be injected into LCD panels is very smaller than the amount of liquid crystal contained in a container. Besides, once liquid crystal is exposed to the air or a specific gas, the liquid crystal is degraded by reacting with the specific gas. This may cause a large amount of the liquid crystal remaining after the filling to be discarded, even if liquid crystal contained in a container is used to fill a plurality of LCD panels. As the expensive liquid crystal is discarded, the LCD panels may have high costs. This may lower the price competitiveness.

In order to overcome the problems of the vacuum injection method, a dropping method may be used.

As shown in FIG. 5, after the alignment layer test (S105), a predetermined seal pattern is formed on the color filter substrate by using a sealant, and a liquid crystal layer is formed on the array substrate (S106′, S107′).

According to this dropping method, an LC layer is formed by dropping and dispensing liquid crystal on an image display region of a first mother substrate having a large area where a plurality of array substrates are arranged, or a second mother substrate where a plurality of color filter substrates are arranged, and then by uniformly applying the liquid crystal to the entire part of the image display region, with a pressure to attach the first and second mother substrates to each other.

In case of forming an LC layer on the LCD panel through the dropping method, a seal pattern has to be implemented as a closed pattern to encompass the outer periphery of a pixel region in order to prevent the liquid crystal from leaking to outside of the image display region.

According to the dropping method, it takes a shorter time to drop liquid crystal than in the vacuum injection method. Furthermore, even if the LCD panel becomes larger, an LC layer may be formed very rapidly.

Besides, only a required amount of liquid crystal is dropped onto a substrate. This may prevent high costs of the LCD panels resulting from that expensive liquid crystal is discarded in the vacuum injection method. This may enhance the price competitiveness.

Then, the first and second mother substrates having liquid crystal dropped thereon and a sealant coated thereon are aligned with each other, and then are attached to each other by the sealant with a pressure. And, the dropped liquid crystal is uniformly dispensed onto the entire part of the LCD panel (S108′). Through these processes, a plurality of LCD panels are formed on the attached first and second mother substrates having an LC layer interposed therebetween. These glass substrates are cut into a plurality of LCD panels, and each separated LCD panel is inspected, thereby fabricating an LCD device (S109′, S110′).

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A rubbing method, comprising:
loading a substrate having an alignment layer formed thereon on a stage;
performing a primary rubbing process on the alignment layer, by rotating a first rubbing roll on which a first rubbing cloth is rolled, in an opposite direction to a forming direction of a desired pretilt angle; and
performing a secondary rubbing process on the primarily-rubbed alignment layer, by rotating a second rubbing roll on which a second rubbing cloth is rolled, in the forming direction of the desired pretilt angle.

2. The method of claim 1, wherein the primary rubbing process is performed with moving at least one of the stage having the substrate loaded thereon and the first rubbing roll.

3. The method of claim 1, wherein the secondary rubbing process is performed with moving at least one of the stage having the substrate loaded thereon and the second rubbing roll.

4. The method of claim 1, wherein hairs of the first and second rubbing clothes are configured to be inclined toward one of a left side, a right side and a middle side with respect to a vertical direction of rotation axes of the first and second rubbing rolls.

5. The method of claim 4, wherein the hairs have an inclination angle of 5°˜37° in the right and left directions.

6. A method of fabricating a liquid crystal display (LCD) device, the method comprising:
providing a mother substrate having thereon a plurality of array substrates and a mother substrate having thereon plurality of color filter substrates;
performing an array process with respect to the array substrates, and performing a color filter process with respect to the color filter substrates;
forming an alignment layer on each surface of the mother substrates having undergone the array process and the color filter process;
performing a primary rubbing process on the alignment layer, by rotating a first rubbing roll on which a first rubbing cloth is rolled, in an opposite direction to a forming direction of a desired pretilt angle;
performing a secondary rubbing process on the primarily-rubbed alignment layer, by rotating a second rubbing roll on which a second rubbing cloth is rolled, in the forming direction of the desired pretilt angle;
attaching the pair of mother substrates having undergone the rubbing process to each other; and
cutting the attached mother substrates into a plurality of unit LCD panels.

7. The method of claim 6, wherein the step of forming an alignment layer comprises:
depositing an alignment material formed of an organic polymer on the mother substrate;
primarily drying the alignment material to a temperature of 60° C.˜80° C.; and
hardening the alignment material at a temperature of 80° C.˜200° C.

8. The method of claim 6, wherein the primary rubbing process is performed with moving at least one of the stage having the mother substrate loaded thereon, and the first rubbing roll.

9. The method of claim 6, wherein the secondary rubbing process is performed with moving at least one of the stage having the mother substrate loaded thereon, and the second rubbing roll.

10. The method of claim 6, wherein hairs of the first and second rubbing clothes are configured to be inclined toward one of a left side, a right side and a middle side with respect to a vertical direction of rotation axes of the first and second rubbing rolls.

11. The method of claim 10, wherein the hairs have an inclination angle of 5°˜37° in the right and left directions.

12. The method of claim 6, wherein liquid crystal is dropped onto one of the mother substrates having undergone the rubbing process and having thereon the array substrates and the color filter substrates, and a sealant is coated onto another mother substrate.

13. The method of claim 12, wherein the mother substrate having the liquid crystal dropped thereon is attached to the mother substrate having the sealant coated thereon.

14. The method of claim 6, wherein a spacer is formed on one of the mother substrates having undergone the rubbing process and having thereon the array substrates and the color filter substrates, and a sealant is coated onto another mother substrate.

15. The method of claim 14, wherein the mother substrate having the spacer formed thereon is attached to the mother substrate having the sealant coated thereon.

16. The method of claim 15, wherein the attached mother substrates are cut into a plurality of LCD panels, and liquid crystal is injected into the LCD panels.
